(19) United States
(12) Patent Application Publication
(10) Pub. No.: US 2020/0307003 A1
(43) Pub. Date: Oct. 1, 2020

(54) Folding Pocket Tool

(71) Applicant: True Brands Limited, Ringwood (GB)

(72) Inventor: Lee Berman, Bournemouth (GB)

(21) Appl. No.: 16/819,903

(22) Filed: Mar. 16, 2020

(30) Foreign Application Priority Data
Mar. 28, 2019 (GB) 1904317.3
Mar. 28, 2019 (GB) 1904320.7

(51) Int. Cl. B26B 11/00; B25F 1/02

(52) U.S. Cl. CPC B26B 11/00; B26B 1/02; B25F 1/02

(57) ABSTRACT

A pocket knife has a blade pivotally deployable on a handle formed by upper and lower handle plates. Longitudinal channel portions are formed in facing surfaces of the handle pates at their distal ends, which are shaped and dimensioned to form a socket that can engage a standard hexagonal tool bit. A magnet is provided on the root portion of the blade for retaining the tool bit in the socket formed by the channel portions. In a variant, the channel portions are omitted, the hexagonal tool bit is retained in a slot formed in the root portion of the blade, and the ends of the handle plates engage opposite flats of the tool bit.

### PRIORITY CLAIM

The present application claims priority to GB patent application number 1904317.3 filed in the United Kingdom on Mar. 28, 2019 entitled “Folding Pocket Tool” which is incorporated herein by reference in its entirety. The present application also claims priority to GB patent application number 1904320.7 filed in the United Kingdom on Mar. 28, 2019 entitled “Pocket Tool” which is incorporated herein by reference in its entirety.

### FIELD OF THE TECHNOLOGY

The present invention relates to a pocket tool, and particularly a folding pocket tool such as a pocket knife including frame lock and liner lock folding knives. In one aspect, the frame or a liner element is movable within a frame and can be moved to a position in which the blade is locked in an unfolded, deployed configuration.

### BACKGROUND

US 2008/016434A discloses (FIG. 1a) a plate 200 holding a screwdriver bit 220 in a rectangular cut-out formed at one end. GB2563466A (in the name of the present applicant) discloses a folding pocket tool comprising two elongate plates. However it has been found necessary to add a small additional, uppermost plate (FIG. 1 of GB 2563466A) onto the outer surface of one of the plates at the distal end of the tool in order to provide the necessary thickness to accommodate a hexagonal socket opening. The additional plate complicates the manufacture and assembly of the tool but adds little to its functionality. Furthermore the folding pocket tool of GB 2563466A comprises two mutually pivotable and separable plate assemblies and is not suitable for incorporating a penknife-type blade or other relatively large tool which is deployable by unfolding from the handle assembly and is shielded when retracted.

### BRIEF DESCRIPTION OF THE DRAWINGS

Certain aspects of the technology are described below, by way of example only, with reference to FIGS. 1 to 14 of the accompanying drawings, wherein:

FIG. 1 is a perspective view from above of a hexagonal tool bit and a folding pocket knife in accordance with one aspect of the technology in a retracted (folded) configuration;

FIG. 2 is perspective view showing a hexagonal tool bit inserted in a hexagonal socket of a pocket knife in accordance with one aspect of the technology;

FIG. 3 is a plan view from above showing the blade of the knife of FIG. 1;

FIG. 4 is a diagrammatic end elevation of a socket formed in two handle plates and knife blade of the pocket knife of FIGS. 1 to 3;

FIG. 5 is a magnified diagrammatic cross-section of a socket hexagonal tool bit in accordance with one aspect of the technology;

FIG. 6 is a diagrammatic cross-section of a socket hexagonal tool bit in accordance with one aspect of the technology;

FIG. 7 is a diagrammatic cross-section of a socket hexagonal tool bit in accordance with one aspect of the technology;

FIG. 8 is a diagrammatic cross-section of a socket hexagonal tool bit in accordance with one aspect of the technology;

FIG. 9 is a plan view from above of a knife blade in accordance with one aspect of the technology;

FIG. 10 is a perspective view from above of a hexagonal tool bit and folding pocket knife in a partially deployed configuration in accordance with one aspect of the technology;

FIG. 11 is a perspective view from above of a pocket knife showing a hexagonal tool bit at the opposite end to the socket in accordance with one aspect of the technology;

FIG. 12 is a perspective view of a hexagonal tool bit withdrawn from the bit holder in accordance with one aspect of the technology;

FIG. 13 is a perspective view of a pry bar of a pocket knife in accordance with one aspect of the technology; and

FIG. 14 is a partial side elevation showing a pry bar in accordance with one aspect of the technology.

### DESCRIPTION OF ASPECTS OF THE TECHNOLOGY

Although the following detailed description contains many specifics for the purpose of illustration, a person of ordinary skill in the art will appreciate that many variations and alterations to the following details can be made and are considered to be included herein. Accordingly, the following aspects are set forth without any loss of generality to, and without imposing limitations upon, any claims set forth. It is also to be understood that the terminology used herein is for the purpose of describing particular aspects of the technology only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a line” includes a plurality of such lines.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this specification it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the aspects described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the aspects described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one aspect,” or “in one aspect,” herein do not necessarily all refer to the same aspect or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.8, 3, 3.1, 4, 4.6, and 5, individually.

This same principle applies to ranges reciting only one numerical value as a minimum or a maximum. Furthermore, such an interpretation should apply regardless of the breadth of the range or the characteristics being described.

As used herein, “enhanced,” “improved,” “performance-enhanced,” “upgraded,” “improvement,” and the like, when used in connection with the description of a device, component, or process, refers to a characteristic of the device, component or process that provides measurably better form, function, or outcome as compared to previously known devices or processes. This applies both to the form and function of individual components in a device or process, as well as to such devices or processes as a whole.

Reference throughout this specification to “an example” means that a particular feature, structure, or characteristic described in connection with the example is included in at least one aspect. Thus, appearances of the phrases “in an example” in various places throughout this specification are not necessarily all referring to the same aspect.

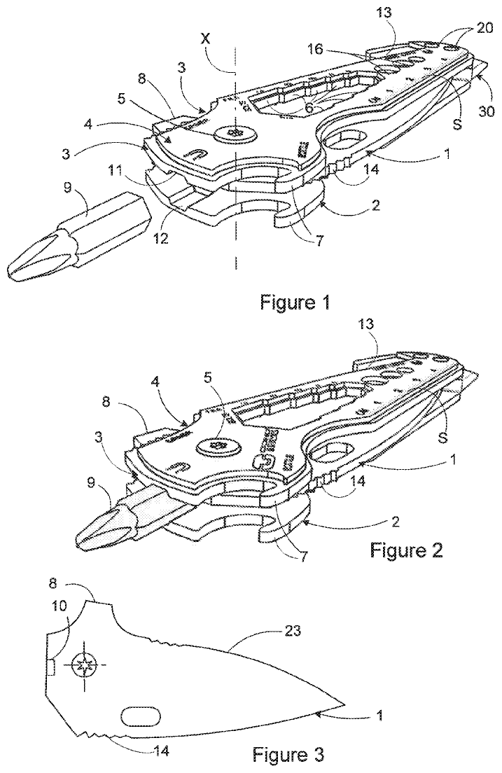

Referring to FIG. 1, a pocket knife is shown which comprises a stainless steel knife blade 1 connected by a threaded pivot bushing assembly 5 to lower and upper handle plates (or scales) 2 and 3. An uppermost cover plate 4 which includes a millimeter scale S at one long edge thereof is secured against the outer surface of upper handle plate 3 by the pivot bushing assembly 5 at the forward (distal) end of the tool and by two machine screws 20 at the rear (proximal) end of the tool. These machine screws also extend through a pry bar tool 30 which spaces apart the upper and lower handle plates at the rear (proximal) end of the tool.

The handle plates 2 and 3 and the cover plate 4 include registering cut-outs in their mid-regions which define graduated hexagonal spanner portions 6. The handle plates 2 and 3 and the cover plate 4 include one or more wire-stripper holes 16. The handle plates 2 and 3 include bottle-opener projections 7 at their distal ends. The knife blade 1 includes a transverse screwdriver blade 8 at one side of its root portion and a serrated edge for cutting (e.g., cardboard) at the other side of its root portion. In the retracted configuration shown in FIGS. 1 and 2, the cutting edge 23 of blade 1 is covered by the handle plates. The upper handle plate 3 includes a longitudinal channel portion 11 at its distal edge and the lower handle plate 2 includes a similar longitudinal channel portion 12 at its distal edge, the channel portions having inclined sides and flat bases which are shaped and dimensioned to form a socket which can receive a standard 6 mm hexagonal tool bit 9 (FIG. 2). Other bit storage methods may also be used.

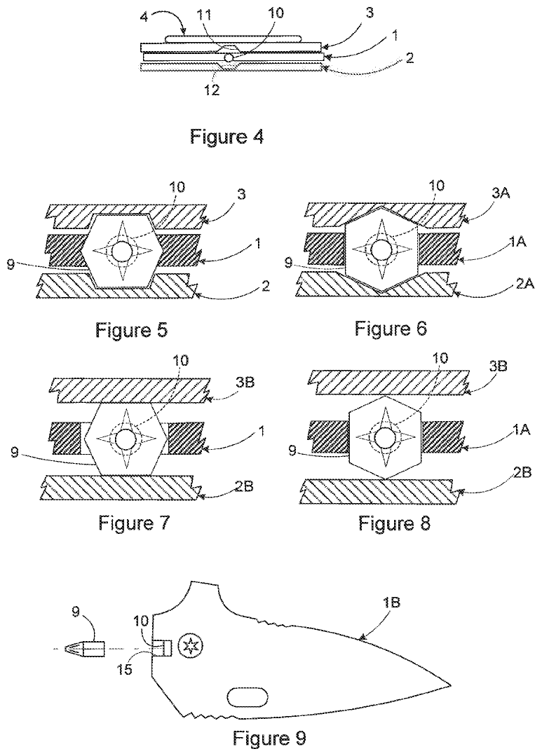

Referring to FIGS. 3 and 4, the end of the hexagonal tool bit 9 abuts against and is retained by a cylindrical magnet 10 which is fixed within a recess in a straight edge of the root portion of knife blade 1. This is shown in more detail in FIG. 5. In use in this aspect, torque is applied to the tool bit 9 only by the handle plates 2 and 3 via their channel portions.

FIGS. 6 and 9 show a variant of the aspect of FIGS. 1 to 5 in which the root portion of knife blade 1B includes a slot 15. Slot 15 holds magnet 10 at its inner end and grips the flats of the tool bit 9, as best seen in FIG. 6. The lower and upper handle plates 2A and 3A have triangular channels shaped to engage the ridges of the tool bit 9. In this aspect, in use, the sides of slot 15 engage the flats of the tool bit 9 and assist in applying torque to the tool bit when the pocket tool is used for screwing or unscrewing.

In the second variant shown in FIG. 7, the lower and upper handle plates 2B and 3B do not have channels but abut against opposite flats of the hexagonal tool bit 9. The slot in the root portion of the knife blade is similar to that shown in FIG. 9, but wider to accommodate the distance between opposite ridges of the hexagonal tool bit 9, as shown.

In the third variant shown in FIG. 8, the knife blade 1B is as shown in FIGS. 6 and 9, including the channel 15 that engages opposite flats of the hexagonal tool bit, but the handle plates 2B and 3B are spaced further apart to correspond to the distance between the opposite ridges of the hexagonal tool bit 9, and therefore do not require channels in their inner surfaces. As shown in one aspect of the technology in FIGS. 6 and 9, in use, the sides of slot 15 engage the flats of the tool bit 9 and assist in applying torque to the tool bit when the pocket tool is used for screwing or unscrewing.

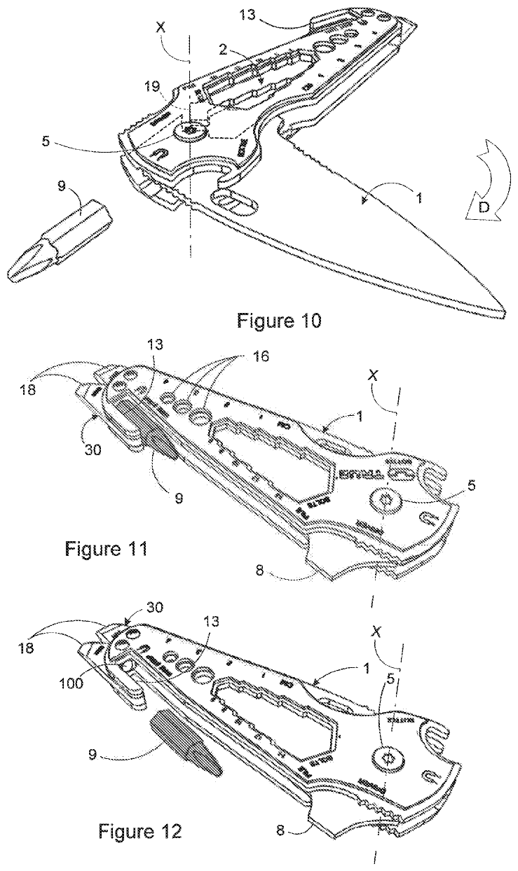

FIG. 10 shows the deployment of the knife blade 1 (as indicated by arrow D) about pivot axis X, following the removal of the hexagonal tool bit 9. A spring bar 19, cantilevered to the proximal end of the handle plate 2, is formed in the lower handle plate 2 by a transverse cut. An expanded head portion of spring bar 19 engages a camming surface (not shown) of the root portion of the knife blade 1 when the latter is fully extended (i.e. pointing down and to the left in FIG. 10) and resists (but does not prevent) retraction of the blade 1 between the handle plates.

The handle plates 2 and 3 and pry bar tool 30 include registering rectangular cut-out portions which form an L-shaped tool bit retainer 13 at their proximal end, as best seen in FIG. 11. Tool bit retainer 13 is shaped and dimensioned to retain a standard hexagonal tool bit 9 against one side of the pocket tool, as shown.

As shown in FIG. 12, a cylindrical magnet 100 is fixed flush to the base of the rectangular cut-out in pry bar tool 30 and, in use, engages the base of the hexagonal tool bit 9 to retain it in the position shown in FIG. 11.

### PRY Bars

Referring to FIG. 11, a pocket knife is shown which comprises a stainless steel knife blade 1 connected by a threaded pivot bushing assembly 5 to lower and upper handle plates (or scales) 2 and 3. An uppermost cover plate 4 which includes a millimeter scale at one long edge thereof is secured against the outer surface of upper handle plate 3 by the pivot bushing assembly 5 at the forward (distal) end of the tool and by two machine screws 20 at the rear (proximal) end of the tool. These machine screws also extend through a pry bar tool 30 which spaces apart the upper and lower handle plates at the rear (proximal) end of the tool.

The handle plates 2 and 3 and the cover plate 4 include registering cut-outs in their mid-regions which define graduated hexagonal spanner portions 6. The handle plates 2 and 3 and the cover plate 4 include one or more wire-stripper holes 16. In one aspect, the handle plates 2 and 3 also include bottle-opener projections 7 at their distal ends.

The knife blade 1 includes a transverse screwdriver blade 8 at one side of its root portion and a serrated edge for cutting (for example, cardboard) at the other side of its root portion. In the retracted configuration shown in FIGS. 1 and 2, the cutting edge of blade 1 is covered by the handle plates.

A spring bar cantilevered to the proximal end of the handle plate 2, is formed in the lower handle plate 2 by a transverse cut. An expanded head portion of spring bar 19 engages a camming surface) of the root portion of the knife blade 1 when the latter is fully extended (i.e., pointing down and to the right in FIG. 11) and resists (but does not prevent) retraction of the blade 1 between the handle plates.

The handle plates 2 and 3 and pry bar tool 30 include registering rectangular cut-out portions which form an L-shaped tool bit retainer 13 at their proximal end, as best seen in FIG. 12. Other bit storage methods may also be used without departing from the scope of the technology described herein.

Tool bit retainer 13 is shaped and dimensioned to retain a standard hexagonal tool bit 9 against one side of the pocket tool, as shown in FIG. 11. In one aspect of the technology, as shown in FIG. 12, a cylindrical magnet 100 is fixed flush to the base of the rectangular cut-out in pry bar tool 30 and, in use, engages the base of the hexagonal tool bit 9 to retain it in the position shown in FIG. 11.

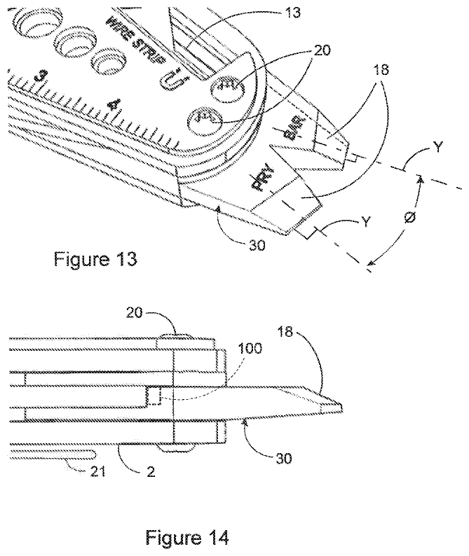

As shown in FIG. 13, pry bar tool 30 is sandwiched between the upper and lower handle plates of the folding pocket knife at their proximal ends and held in position by machine screws 20. In one aspect, the pry bar tool includes two angularly spaced-apart substantially coplanar screwdriver blades 18. Their angular spacing θ between their longitudinal axes Y is such that each can be used as a screwdriver without interference from the other. The angle θ is less than 60 degrees, in one aspect. In yet another aspect, it is less than 50 degrees, less than 40 degrees, or less than 30 degrees. In still another aspect, the angle θ ranges between 10 to 25 degrees or between 15 to 20 degrees. These angles ensure that either of the screwdriver blades 18 can be used as such without the other screwdriver blade fouling the workpiece as the tool is rotated about the axis Y of the screwdriver blade being used.

FIG. 14 shows the retaining magnet 100 mounted in the base of the retainer portion of the pry bar tool 18. A flexible belt clip 21 is optionally provided on the underside of the handle assembly, cantilevered to the distal end of the lower handle plate 2.

1. A folding pocket tool, comprising:
a tool plate pivotally mounted between two spaced-apart elongate handle plates, the elongate handle plates being secured in a mutually aligned configuration;
wherein the folding pocket tool has a folded configuration in which the tool plate is substantially aligned with the elongate handle plates and an unfolded configuration in which the tool plate is deployed from between the handle plates;
wherein the folding pocket tool has a bit holder socket formed by opposing faces of the handle plates.

2. The folding pocket tool of claim 1, wherein the tool plate carries a magnet for retaining a tool bit in the bit holder socket.

3. A folding pocket tool of claim 2 wherein a slot is formed in the tool plate which is shaped and dimensioned to receive a hexagonal tool bit in said bit holder socket.

4. The folding pocket tool of claim 3, wherein the slot has a width corresponding to a space between diametrically opposite ridges of a hexagonal tool bit, wherein opposing faces of the handle plates include channels shaped and dimensioned to fit diametrically opposite flats of a hexagonal tool bit.

5. The folding pocket tool of claim 3, wherein the slot has a width corresponding to a space between diametrically opposite ridges of a hexagonal tool bit, and a gap between opposing faces of the handle plates corresponding to a distance between diametrically opposite flats of a hexagonal tool bit.

6. The folding pocket tool of claim 3, wherein said slot has a width corresponding to a space between diametrically opposite flats of a hexagonal tool bit, and a gap between opposing faces of the handle plates corresponding to a distance between diametrically opposite ridges of a hexagonal tool bit.

7. The folding pocket tool of claim 3, wherein the handle plates include registered cut-out portions that form a bit receptacle for a tool bit.

8. The folding pocket tool of claim 7, wherein the bit receptacle includes a magnet for retaining a tool bit.

9. The folding pocket tool of claim 1, wherein the tool plate is a knife blade.

10. The folding pocket tool of claim 1, further comprising a kit of parts comprising a tool plate and two handle plates.

11. A pocket tool, comprising:
a tool plate pivotally mounted about a first end between two spaced-apart elongate handle plates, the elongate handle plates being secured in a mutually aligned configuration;
two or more angularly spaced-apart substantially coplanar tool blades disposed about a second end of the two-spaced-apart elongate handle plates, the second end being opposite from the first end;
wherein the tool blades are disposed about the handle plates to permit use of both tool blades in combination as a pry bar and use of each tool blade individually.

12. The pocket tool of claim 11, wherein the tool blades are screwdriver blades.

13. The pocket tool of claim 11, wherein the angular spacing between longitudinal axes of the tool blades is less than 60 degrees.

14. The pocket tool of claim 11, wherein the angular spacing between longitudinal axes of the tool blades is less than 50 degrees.

15. The pocket tool of claim 11, wherein the angular spacing between longitudinal axes of the tool blades is less than 40 degrees.

16. The pocket tool of claim 11, wherein the angular spacing between longitudinal axes of the tool blades is less than 30 degrees.

17. The pocket tool of claim 11, wherein the angular spacing between longitudinal axes of the tool blades ranges between 15 and 25 degrees.

18. The pocket tool of claim 11, wherein the angular spacing between longitudinal axes of the tool blades ranges between 15 and 20 degrees.

19. The pocket tool of claim 11, wherein at least one of the tool blades includes a bit retainer.
